(19) United States
(12) Patent Application Publication
(10) Pub. No.: US 2004/0232576 A1
(43) Pub. Date: Nov. 25, 2004

(54) Method of making dental restorations

(76) Inventors: Dmtri Brodkin, Livingston, NJ (US); Carlino Panzera, Hillsborough, NJ (US); Paul Panzera, Moorestown, NJ (US)

Correspondence Address: PENTRON CORPORATION, 53 NORTH PLAINS INDUSTRIAL ROAD, WALLINGFORD, CT, 06492, US

(21) Appl. No.: 10/370,664

(22) Filed: Feb. 20, 2003

Related U.S. Application Data
(63) Continuation-in-part of application No. 09/887,668, filed on Jun. 30, 2000, now Pat. No. 6,554,615.
(60) Provisional application No. 60/142,203, filed on Jul. 2, 1999.

(51) Int. Cl. A61C 13/00

(52) U.S. Cl. 264/16; 433/222.1

(57) ABSTRACT

A method of making a dental restoration comprising forming a ceramic core or an alloy framework; pressing a porcelain onto the core or framework, wherein the porcelain comprises an amorphous glass phase with a maturing temperature less than about 850° C., wherein the amorphous glass phase, in one embodiment, comprises:

| Component | Amount (wt. %) |
|---|---|
| SiO₂ | 55-75 |
| B₂O₃ | 2.6-6 |
| Al₂O₃ | 3-4.9 |
| ZnO | 0-3 |
| CaO | 0-3 |
| MgO | 0.5-3 |
| ZrO₂ | 0-3 |
| BaO | 0-2 |
| Li₂O | 0.8-2 |
| K₂O | 0-6.5 |
| Na₂O | 2-15 |
| Tb₄O₇ | 0-1 |
| TiO₂ | 0-3 |
| CeO₂ | 0-1 |
| F | 0-2 |

### CROSS-REFERENCE TO RELATED APPLICATIONS

This is a continuation-in-part application of U.S. application Ser. No. 09/887,668 filed Jun. 30, 2000 entitled Porcelain Compositions For Low Expansion All-Ceramic Cores And Alloy Frameworks, which claims priority to U.S. Provisional Application No. 60/142,203, filed Jul. 2, 1999, all of which are hereby incorporated by reference.

### BACKGROUND OF THE INVENTION

1. Field of the Invention

This invention relates to a method of making dental restorations, and more specifically to a method of making dental restorations using low expansion, low maturing temperature porcelain compositions.

2. Description of the Related Art

Porcelain materials are used in dentistry in order to obtain natural-looking dental restorations. Porcelains are highly desirable for this purpose since they can be colored to closely resemble the teeth they must replace, resist degradation inside the oral cavity, and remain biocompatible even after years of continuous contact with mammalian tissue. Restorations may be classified as either porcelain-fused-to-metal (PFM) or as all-ceramic restorations.

Typically, PFM restorations are fabricated by applying a dental porcelain powder in aqueous slurry to a metal alloy framework and firing the porcelain at high temperature to form a tight, impervious porcelain layer having the appearance of natural dentition. Those skilled in the art recognize that it is important that the firing temperature of the porcelain must be compatible with the material used for the metal framework. For example, titanium and titanium alloys require overlay porcelain having firing temperatures below the temperature at which the alpha crystalline structure transforms to the less useful beta crystalline structure. It is further important that the thermal expansion behavior of the porcelain be compatible with the thermal expansion behavior of the metal so that no stress cracks are produced in the porcelain layer due to thermal expansion mismatch stress occurring during firing and cooling down.

Today, there is an increasing trend in dentistry toward the use of ceramic cores in lieu of metal alloy frameworks to provide all-ceramic dental restorations. Where a ceramic is employed as the core of a dental restoration, any porcelain applied to the ceramic framework or coping must also possess a coefficient of thermal expansion (CTE) that is compatible with that of the ceramic in order to avoid production of stress cracks in the core and/or porcelain.

Metal alloys and ceramics employed in the manufacture of dental restorations have typically possessed moderately high coefficients of thermal expansion, in the range from about 13×10⁻⁶/° C. to about 17×10⁻⁶/° C. Many porcelain compositions are known in the art which are thermally compatible with these moderately high expansion core materials and provide smooth, fused glassy surface on the resulting dental restorations. However, few porcelain compositions are suitable for use with low expansion alloys and ceramics, i.e., those alloys and ceramics having coefficients of thermal expansion in the range of about 7×10⁻⁶/° C. to about 13×10⁻⁶/° C.

Accordingly, there remains a need in the art for porcelain compositions thermally compatible with low expansion core materials; having maturing temperatures below about 850° C.; which are chemically and thermally stable; and which provide a smooth, non-abrasive surface when applied to low expansion alloys and porcelains.

### BRIEF SUMMARY OF THE INVENTION

The above mentioned drawbacks and disadvantages are overcome or alleviated by a dental porcelain composition comprising an amorphous glass phase with a maturing temperature less than about 850° C., wherein the amorphous glass phase, in one embodiment, comprises:

| Component | Amount (wt. %) |
|---|---|
| SiO₂ | 55-75 |
| B₂O₃ | 2.6-6 |
| Al₂O₃ | 3-4.9 |
| ZnO | 0-3 |
| CaO | 0-3 |
| MgO | 0.5-3 |
| ZrO₂ | 0-3 |
| BaO | 0-2 |
| Li₂O | 0.8-2 |
| K₂O | 0-6.5 |
| Na₂O | 2-15 |
| Tb₄O₇ | 0-1 |
| TiO₂ | 0-3 |
| CeO₂ | 0-1 |
| F | 0-2 |

The above discussed and other features and advantages of the present invention will be appreciated and understood by those skilled in the art from the following detailed description.

### DETAILED DESCRIPTION OF THE PREFERRED EMBODIMENTS

A dental porcelain composition which is low fusing and suitable for use with titanium, titanium alloys and ceramic cores, and which provides an extremely smooth surface for dental restorations, comprises an amorphous glass phase with a maturing temperature less than about 850° C. and a coefficient of thermal expansion (25° C. to 500° C.) of about 7×10⁻⁶/° C. to about 11×10⁻⁶/° C. The compositions find particular utility as overlay porcelains for veneers, single and multi unit restorations such as dental crowns and bridges (fixed partial dentures), inlays and onlays.

The dental porcelain composition comprises, on a weight percent basis the following compositions in Table 1 below:

TABLE 1

| Oxide | Range 1 | Range 2 | Range 3 | Range 4 |
|---|---|---|---|---|
| SiO₂ | 55-75 | 55-75 | 55-75 | 55-75 |
| B₂O₃ | 2.6-6 | 2.6-6 | 2.6-6 | 2.6-6 |
| Al₂O₃ | 3-4.9 | 3-9 | 3-9 | 2-4.9 |
| ZnO | 0-3 | 0-3 | 0-3 | 0-3 |
| CaO | 0-3 | 0-3 | 0-3 | 0-3 |
| MgO | 0.5-3 | 0-3 | 0-3 | 0.8-3 |
| ZrO₂ | 0-3 | 0-3 | 0-3 | 0-3 |
| BaO | 0-2 | 0-2 | 0-2 | 0-2 |
| Li₂O | 0.8-2 | 0-2 | 0-2 | 0.8-2 |
| K₂O | 0-6.5 | 0.5-4 | 0-6.5 | 6-10 |
| Na₂O | 2-15 | 2-15 | 14.1-17 | 6-10 |
| Tb₄O₇ | 0-1 | 0-1 | 0-1 | 0-1 |
| TiO₂ | 0-3 | 0-3 | 0-3 | 0-3 |
| CeO₂ | 0-1 | 0-1 | 0-1 | 0-1 |
| F | 0-2 | 0-2 | 0-2 | 0-2 |
| Glass Transition | 450-600 | 450-600 | 450-600 | 450-600 |
| Temperature, ° C. | | | | |
| Dilatometric Softening | 520-650 | 520-650 | 520-650 | 520-650 |
| Temperature, ° C. | | | | |
| Firing Temperature, ° C. | Less than | Less than | Less than | Less than |
| | 850° C. | 850° C. | 850° C. | 850° C. |
| CTE × 10⁻⁶/° C. | 7-11 | 7-11 | 7-11 | 7-11 |
| (25° C.-500° C.) | | | | |

The dental porcelain compositions are amorphous glasses that mature at a temperature consistent with the thermal stability temperature of low expansion porcelain cores and alloy frameworks. That is, the porcelain forms a chemical bond with the core and has a thermal expansion value within about 2×10⁻⁶/° C. of that of the core. Components such as Li₂O, BaO, F, TiO₂, ZnO and SnO₂ are added to these glasses to provide wettability and good bonding to the cores used with these porcelains. ZnO and TiO₂ are particularly useful if the porcelain composition is to be used in conjunction with titanium and titanium alloys.

The porcelain compositions are chemically and thermally stable and have sufficient viscosity at firing temperature to maintain the required shape of dental restorations mimicking that of tooth anatomy. The porcelain compositions are fired at temperatures not exceeding about 850° C. The porcelain composition fires to nearly 100% of theoretical density, thus forming a tight impervious surface necessary in the oral environment.

A preferred feature of the present composition is a combination of Al₂O₃, B₂O₃, and MgO effective to achieve low maturing temperature, while at the same time maintaining low thermal expansion and high chemical durability. While B₂O₃ often lowers thermal expansion and maturing temperature, it can simultaneously decrease the chemical durability of porcelain if it comprises more than about 3-4 wt % of the total composition. To lower expansion and maturing temperature while maintaining high chemical durability, B₂O₃ is therefore preferably used in combination with Al₂O₃ and MgO.

The porcelain compositions can be prepared by melting together sufficient precursor components to yield the compositions shown in the above table. Suitable precursors include silica, alumina, boric acid, feldspar, calcium carbonate, sodium carbonate, potassium carbonate, lithium carbonate or lithium fluoride, or if desired, the actual oxides, blended in proportion to yield the compositions shown in the above table.

The preparation of such materials is well known in the art. After the materials are blended, preferably in finely divided powder form such as powder sufficiently fine to pass through a 200 mesh screen (Tyler series), the precursors and/or oxides are heated to a temperature of at least about 1100° C., and preferably to at least about 1230° C., in a crucible to form a glass.

The molten glass may then be quenched in water, dried, and ground in a ball mill, to provide the porcelain material in the form of a powder.

It is preferred that the powder is ground finely enough so that it will pass through a 200 mesh screen (Tyler series). Opacifiers, pigments and fluorescing agents are then added to this powder in the amount of up to about 5 wt % for body and incisal porcelain compositions and up to 30 wt % for opaques.

The properties of the porcelain composition can be adjusted by applying the following well-known principles. Within the ranges of component proportions set forth in the above table, the coefficient of thermal expansion can be increased, if desired, by decreasing the proportion of SiO₂ and/or B₂O₃ and/or by increasing the proportion of the alkali metal oxides. The fusion point can be reduced by increasing the proportion of B₂O₃, CaO, and/or the alkali metal oxides. As between the two alkali metal oxides, an increase in the Na₂O:K₂O ratio may lower the fusion point. However, when complex mixtures of alkali oxides are used, the so-called mixed alkali phenomenon affects the properties of the composition in a non-linear fashion. It is well within the skill of the porcelains art to apply these principles to make fine adjustments to the thermal expansion coefficients and fusion temperatures.

If desired, in order to achieve proper aesthetics, one or more layers of the porcelain composition can be applied over the core with each layer being separately fired. Thus, for example, an opaceous layer containing an opacifying agent such as TiO₂, SnO₂, Al₂O₃, ZnO, CeO₂, ZrO, ZrSiO₄ and the like can be applied over the core and fired. Thereafter, or in lieu thereof, a stain layer can be applied containing one or more conventional pigments such as vanadates, manganates, chromates, or other transition metal compounds, to tint the stain layer to the desired shade. The opaceous and/or stain layer can then be overcoated (after sequential firing) with a translucent layer of the porcelain composition of the present invention. In this manner, special effects can be obtained, e.g., a different shade at the tip of the restoration than at the gingival area. The layers are applied to the core in the usual manner, as by applying a paste of the porcelain powder in water over the core, shaping to the desired configuration, and then firing.

Alternatively, the layers may be applied by forming the porcelains into a pellet and pressing the pellet onto the ceramic core or alloy framework. This process involves the lost wax process wherein a wax layer is built on the ceramic core or alloy framework. The ceramic core or alloy framework layered with wax is covered with refractory investment material and placed in a kiln wherein the wax is “burned out” leaving a mold within the refractory investment material. The porcelain pellets produced herein may then be pressed into the mold formed by the refractory investment material. There are many ways to press porcelain onto metal and ceramic cores, including but not limited to, pressing to metal, injection molding, heat pressing and hot pressing. After the porcelain has been applied in this manner, the refractory investment material is removed and the restorative may be finished with further layers of porcelain, as desired.

In an alternative embodiment, amorphous glasses in the form of powder (a frit) are mixed with a second glass frit, glass-ceramic frit and/or crystalline filler to modify the firing temperature and thermal expansion. Suitable crystalline fillers can be mullite or alumina particles to lower the thermal expansion to about 6 to about 7×10⁻⁶/° C. Preferably the average particle size of the crystalline filler is less than about 10 microns, and more preferably, less than about 3 microns. The second frit can be a lower maturing temperature glass to lower the composition's maturing temperature and increase the expansion to about 11×10⁻⁶/° C.

Preferred core materials include ceramics comprising lithium disilicate glass ceramics, zirconia, and micaceous glass ceramics, as well as other ceramic cores with thermal expansions in the range of about 7 to about 13×10⁻⁶/° C. Suitable metal and alloy cores include those based on Ti and Ti alloys.

The present method is further demonstrated by the following examples, which are meant to be illustrative, not limiting.

### EXAMPLES

Table 2 shows exemplary formulations for the manufacture of the present porcelains. (All amounts are in weight percent.)

TABLE 2

| Oxide | 1 | 2 | 3 | 4 | 5 | 6 | 7 | 8 | 9 | 10 | 11 |
|---|---|---|---|---|---|---|---|---|---|---|---|
| SiO₂ | 66.91 | 67.94 | 65.90 | 65.80 | 67.46 | 65.56 | 64.81 | 62.09 | 68.0 | 67.4 | 65.7 |
| B₂O₃ | 3.31 | 3.36 | 3.26 | 3.21 | 3.29 | 3.24 | 5.49 | 5.42 | 3.3 | 3.1 | 3.1 |
| Al₂O₃ | 4.84 | 4.92 | 4.77 | 4.80 | 4.92 | 4.74 | 4.83 | 7.94 | 4.9 | 4.9 | 4.9 |
| ZnO | 2.58 | 2.62 | 2.54 | 2.50 | 2.56 | 2.52 | 2.57 | 2.53 | 2.6 | 2.2 | 2.3 |
| CaO | 1.78 | 1.80 | 1.75 | 1.77 | 1.82 | 1.74 | 1.77 | 1.75 | 1.8 | 1.9 | 1.8 |
| MgO | 1.28 | 1.30 | 1.26 | 1.22 | 1.25 | 1.25 | 1.27 | 1.26 | 1.3 | 1.2 | 1.2 |
| ZrO₂ | — | — | — | — | — | — | — | — | — | 0.1 | — |
| BaO | 1.21 | 1.23 | 1.20 | 1.18 | 1.21 | 1.19 | 1.21 | 1.19 | 1.2 | 1.0 | 1.1 |
| Li₂O | 0.00 | 1.44 | 0.93 | 0.92 | 0.94 | 1.85 | — | 0.00 | 1.0 | 1.0 | 1.0 |
| K₂O | 0.00 | 0.00 | 7.34 | 7.35 | 7.53 | 11.69 | — | 0.00 | 7.6 | 8.1 | 7.7 |
| Na₂O | 14.71 | 11.95 | 7.73 | 8.02 | 8.22 | 2.88 | 14.67 | 14.48 | 8.3 | 8.7 | 8.10 |
| Tb₄O₇ | 0.59 | 0.60 | 0.58 | — | — | 0.58 | 0.59 | 0.58 | — | — | 0.52 |
| TiO₂ | 2.53 | 2.57 | 2.49 | 2.45 | 0.00 | 2.48 | 2.52 | 2.49 | — | — | 2.2 |
| CeO₂ | 0.27 | 0.28 | 0.27 | 0.79 | 0.81 | 0.27 | 0.27 | 0.27 | — | — | 0.24 |
| F | — | — | — | — | — | — | — | — | — | 0.3 | 0.2 |
| Glass Transition | 545 | 520 | 526 | — | — | 523 | 574 | 574 | 520 | 510 | 510 |
| Temperature, ° C. | | | | | | | | | | | |
| Dilatometric | 606 | 585 | 595 | — | — | 592 | 618 | 628 | — | — | — |
| Softening | | | | | | | | | | | |
| Temperature, ° C. | | | | | | | | | | | |
| Firing | — | — | 800 | — | — | — | — | — | 800 | 760-770 | 760-770 |
| Temperature,° C. | | | | | | | | | | | |
| CTE × 10⁻⁶/° C. | 8.4 | 8.4 | 9.0 | — | — | 9.0 | 8.8 | 8.7 | 9.5 | 9.5-10 | 9.5 |
| (25-500° C.) | | | | | | | | | | | |

The porcelain composition of Example 3 was applied as an overlay porcelain on a heat-pressed lithium disilicate core (OPC 3G™, available from American Thermocraft Corporation) and a micaceous core (Macor™, available from Corning) which had been milled using a CAD/CAM device in the shape of crowns and three unit bridges. Both ceramic cores had a thermal expansion of about 10×10-6/° C. Crowns were made using standard powder build-up techniques and fired at 800° C. No cracks were observed after 6 successive firings.

The two frit porcelain compositions of Examples 10 and 11 were applied as overlay porcelain on a heat-pressed lithium disilicate core (OPC 3G™, available from American Thermocraft Corporation) in the shape of crowns and three unit bridges. These restorations were subjected to up to six firings at the temperature shown in the table. No cracking or distortion was observed.

The porcelain composition of Examples 3, 9 and 10 were applied to yttria stabilized tetragonal zirconia polycrystal (TZP) coping. The coping was produced from proprietary material provided by Coors Ceramics of Golden, Colo. by the process disclosed in co-pending, co-assigned U.S. patent application Ser. No. 09/376,921, now U.S. Pat. No. 6,354,836, which is incorporated by reference herein. These restorations were subjected to up to six firings at the temperature shown in the table. No cracking or distortion was observed.

The porcelain composition of Example 9 was used to make specimens for chemical solubility and strength measurements according to ISO 6872 and ISO 9694 specifications. Disks for chemical solubility testing and bars for 3 point bend test were wet condensed in the die and fired according to the ISO 6872 specifications. Solubility was 20 micrograms/ cm2 and 3 point bend strength was 105±23 Mpa.

The following Example 12 further illustrates the invention.

### Example 12

The porcelain frit composition of Example 12 (within range 4 of Table 1) was mixed with various amounts of opacifying, fluorescing and opalescing agents, and inorganic pigments as set forth in Table 3 below to produce a variety of incisal (enamels) and body (dentine) porcelain powders. These shaded porcelain powders were layered onto various all-ceramic cores and Ti frameworks as summarized in Table 4 below.

TABLE 3

| Oxide Component | Example 12 |
|---|---|
| SiO2 | 68.9 |
| B2O3 | 2.8 |
| Al2O3 | 4.0 |
| ZnO | 2.6 |
| CaO | 1.8 |
| MgO | 1.3 |
| BaO | 1.2 |
| Li2O | 1.0 |
| K2O | 7.7 |
| Na2O | 8.7 |

Additives:

| | |
|---|---|
| ZrO2 (as opacifier) | 0-0.4 |
| Fluorescing agent | 0.03-0.2 |
| (proprietary formula) | |
| Opalescing agent | 0-0.4 |
| (proprietary formula) | |
| Pigments | 0-4.5 |

Physical Properties:

| | |
|---|---|
| Firing temperature, ° C. | 760-774 |
| CTE (25°-500° C.), | 9.7 ± 0.5 |
| 10⁻⁶ × ° C.⁻¹ | |
| Glass Transition T-re, ° C. | 500 ± 20 |
| 3-pt Bend Strength per ISO6872, MPa | 106 ± 20 |
| Solubility per ISO9693, μg/cm² | 7 |
| | (Based on three parallel |
| | tests with 30 specimens |
| | weighted together before |
| | and after the test.) |
| Solubility per ISO6872, μg/cm² | (Since solubility is |
| | very low our analytical |
| | balance is not accurate |
| | enough to register weight |
| | loss in this test with |
| | any degree of reliability.) |

TABLE 4

| | | | CTE | | | |
|---|---|---|---|---|---|---|
| Core | Brand name and | Fabrication | 25-500° C. | Single | | Super Shape |
| material | Manufacturer, | Process | ppm | units | Bridges | test¹ |
| Mica Glass | MACOR ® Machinable | CAD/CAM | 9.4 | N3 | N1 | |
| Ceramic | Glass Ceramic Corning | | | | | |
| Ti comercially | R/1 ™ | cast | 9.5 | N2 | | |
| pure (c.p.) | Pentron | | | | | |
| Ti c.p. | R/1 ™ | CAD/CAM | 9.5 | N2 | | |
| | Pentron | | | | | |
| Ti-6-4 Alloy | R/2 ™ | cast | 10.2 | N2 | | |
| | Pentron | | | | | |
| Ti c.p. | Tritan Til/31 ™ | cast | | | C1 (3-unit with Tyspar | |
| | Dentaurum | | | | Opaque) N1 (3-unit | |
| | | | | | with Noritake Opaque) | |
| YTZP | FZM/K ™ Friatec | Hand-milled pontics/ | 10.6 | | N1 (3-unit framework | |
| | | inserts for 3G | | | made by firing 3G | |
| | | | | | pellet powder on a | |
| | | | | | refractory die with | |
| | | | | | YTZP pontic) | |
| YTZP | K-188 ™ Coors | CAD/CAM | 10.0 | N4 | | |
| YTZP | Blocks sintered at ATC | CAD/CAM | 10.6 | N4 (abnormally | | |
| | pressed from TZ-3YSB-E ™ | | | large molars) | | |
| | powder (TOSOH), | | | | | |
| YTZP | Cercon ® Zirconia | CAD/CAM | | N4 | N2 | Passed |
| | Dentsply | | | | | |
| YTZP | Procera ® AllZirkon | | | N4 (2 molars, | | |
| | Nobel Biocare | | | 2 centrals) | | |

YTZP- Yttria Stabilized Tetragonal Zirconia Polycrystal - zirconia doped with about 3 mole % of Y₂O₃ to stabilize the tetragonal phase.
N# - no cracking, number of units
C# - cracked, number of units
¹One of the samples was tested under the Porcelain-Alloy Compatibilty Test (PACT) as described by A. Prasad et al. in “A New Dimension in Evaluation of Porcelain-Alloy Compatibility”, pp 65-74, In Jack D. Preston (ed.) Perspectives in Dental Ceramics: Proceedings of the Fourth International Symposium on Ceramics, Chicago, 1985.

In addition small cylinders (pellets) of about 2 grams in weight were fabricated from the porcelain frit composition of example 12 by dry pressing the porcelain powder using a channel die and firing the compacts at 775° C. in a dental furnace. The resulting pellets were heat pressed onto Cercon® YTZP cores (Dentsply) produced by CAD/CAM and a Ti/R2 alloy framework using conventional heat pressing (aka injection molding techniques) in an Autopress-Plus pressing furnace available from Pentron Laboratory Technologies, Wallingford, Conn. This process involves the lost wax process wherein a wax layer is built on the ceramic core or alloy framework. The ceramic core or alloy framework layered with wax is covered with refractory investment material and placed in a kiln wherein the wax is “burned out” leaving a mold within the refractory investment material. The porcelain pellets produced herein may then be pressed into the mold formed by the refractory investment material. After the porcelain has been applied in this manner, the refractory investment material is removed and the restorative may be finished with further layers of porcelain, as desired.

While preferred embodiments have been shown and described, various modifications and substitutions may be made thereto without departing from the spirit and scope of the invention. Accordingly, it is to be understood that the present invention has been described by way of illustration and not limitations.

What is claimed is:

1. A method of making a dental restoration comprising:
forming a ceramic core or an alloy framework;
pressing a porcelain onto the core or framework, wherein the porcelain comprises an amorphous glass phase with a maturing temperature less than about 850° C., said amorphous glass phase comprising:

| Component | Amount (wt. %) |
|---|---|
| SiO₂ | 55-75 |
| B₂O₃ | 2.6-6 |
| Al₂O₃ | 3-4.9 |
| Na₂O | 2-15 |
| MgO | 0.5-3 |
| Li₂O | 0.8-2 |

2. The method of claim 1 wherein the porcelain composition further comprises:

| Component | Amount (wt. %) |
|---|---|
| ZnO | 0-3 |
| CaO | 0-3 |
| ZrO₂ | 0-3 |
| BaO | 0-2 |
| K₂O | 0-6.5 |
| Tb₄O₇ | 0-1 |
| TiO₂ | 0-3 |
| CeO₂ | 0-1 |
| F | 0-2 |

3. The method of claim 1 wherein the porcelain further comprises a crystalline filler.

4. The method of claim 1 wherein the porcelain further comprises a glass powder with a lower maturing temperature than said amorphous glass.

5. The method of claim 1 wherein the ceramic core is selected from the group consisting of lithium disilicate glass ceramics, zirconia, and micaceous glass ceramics.

6. The method of claim 1 wherein the alloy framework is selected from the group consisting of titanium, and titanium alloys.

7. The method of claim 1 wherein the core or alloy framework has a thermal expansion of about 7 to about 13×10⁻⁶/° C.

8. The method of claim 1 wherein the porcelain in formed into a pellet for pressing.

9. The method of claim 1 wherein pressing a porcelain onto the core or framework is a technique selected from the group consisting of pressing to metal, injection molding, heat pressing and hot pressing.

10. A method of making a dental restoration comprising:
forming a ceramic core or an alloy framework;
pressing a porcelain onto the core or framework, wherein the porcelain comprises an amorphous glass phase with a maturing temperature less than about 850° C., said amorphous glass phase comprising:

| Component | Amount (wt. %) |
|---|---|
| SiO₂ | 55-75 |
| B₂O₃ | 2.6-6 |
| Al₂O₃ | 2-4.9 |
| Na₂O | 6-10 |
| K₂O | 6-10 |
| Li₂O | 0.8-2 |
| MgO | 0.8-3 |

11. The method of claim 9 wherein the porcelain composition of claim 10 further comprises:

| Component | Amount (wt. %) |
|---|---|
| ZnO | 0-3 |
| CaO | 0-3 |
| ZrO₂ | 0-3 |
| BaO | 0-2 |
| Tb₄O₇ | 0-1 |
| TiO₂ | 0-3 |
| CeO₂ | 0-1 |
| F | 0-2 |
| P₂O₅ | 0-2 |

12. The method of claim 10 wherein the porcelain composition further comprises crystalline filler.

13. The method of claim 10 wherein the porcelain composition further comprises a glass powder with a lower maturing temperature than said amorphous glass.

14. The method of claim 10 wherein the ceramic core is selected from the group consisting of lithium disilicate glass ceramic, zirconia, and micaceous glass ceramics.

15. The method of claim 10 wherein the alloy framework is selected from the group consisting of titanium and titanium alloys.

16. The method of claim 10 wherein the ceramic core or alloy framework has a thermal expansion of about 7 to about 13×10⁻⁶/° C.

17. The method of claim 10 wherein the porcelain in formed into a pellet for pressing.

18. The method of claim 10 wherein pressing a porcelain onto the core or framework is a technique selected from the group consisting of pressing to metal, injection molding, heat pressing and hot pressing.

19. A method of making a dental restoration comprising:
forming a ceramic core or an alloy framework;
pressing a porcelain onto the core or framework, wherein the porcelain comprises a dental porcelain composition comprising an amorphous glass phase with a maturing temperature less than about 850° C., said amorphous glass phase comprising:

| Component | Amount (wt. %) |
|---|---|
| SiO₂ | 55-75 |
| B₂O₃ | 2.6-6 |
| Al₂O₃ | 3-9 |
| Na2O | 2-15 |
| K₂O | 0.5-4 |
| ZnO | 0-3 |
| CaO | 0-3 |
| MgO | 0-3 |
| ZrO₂ | 0-3 |
| BaO | 0-2 |
| Li₂O | 0-2 |
| Tb₄O₇ | 0-1 |
| TiO₂ | 0-3 |
| CeO₂ | 0-1 |
| F | 0-2 |

20. The method of claim 19 wherein the porcelain further comprises crystalline filler.

21. The method of claim 19 wherein the porcelain further comprises a glass powder with a lower maturing temperature than said amorphous glass.

22. The method of claim 19 wherein the ceramic core is selected from the group consisting of lithium disilicate glass ceramic, zirconia, and micaceous glass ceramics.

23. The method of claim 19 wherein the alloy framework is selected from the group consisting of titanium and titanium alloys.

24. The method of claim 19 wherein the ceramic core or alloy framework has a thermal expansion of about 7 to about 13×10⁻⁶/° C.

25. The method of claim 19 wherein the porcelain in formed into a pellet for pressing.

26. The method of claim 19 wherein pressing a porcelain onto the core or framework is a technique selected from the group consisting of pressing to metal, injection molding, heat pressing and hot pressing.

27. A method of making a dental restoration comprising:
forming a ceramic core or an alloy framework;
pressing a porcelain onto the core or framework, wherein the porcelain comprises an amorphous glass phase with a maturing temperature less than about 850° C., said amorphous glass phase comprising:

| Component | Amount (wt. %) |
|---|---|
| SiO₂ | 55-75 |
| B₂O₃ | 2.6-6 |
| Al₂O₃ | 3-9 |
| Na₂O | 14.1-17 |
| ZnO | 0-3 |
| CaO | 0-3 |
| MgO | 0-3 |
| ZrO₂ | 0-3 |
| BaO | 0-2 |
| Li₂O | 0-2 |
| K₂O | 0-6.5 |
| Tb₄O₇ | 0-1 |
| TiO₂ | 0-3 |
| CeO₂ | 0-1 |
| F | 0-2 |

28. The method of claim 27 wherein the porcelain further comprises crystalline filler.

29. The method of claim 27 wherein the porcelain further comprises a glass powder with a lower maturing temperature than said amorphous glass.

30. The method of claim 27 wherein the ceramic core is selected from the group consisting of lithium disilicate glass ceramic, zirconia, and micaceous glass ceramics.

31. The method of claim 27 wherein the alloy framework is selected from the group consisting of titanium and titanium alloys.

32. The method of claim 27 wherein the ceramic core or alloy framework has a thermal expansion of about 7 to about 13×10⁻⁶/° C.

33. The method of claim 27 wherein the porcelain in formed into a pellet for pressing.

34. The method of claim 27 wherein pressing a porcelain onto the core or framework is a technique selected from the group consisting of pressing to metal, injection molding, heat pressing and hot pressing.
